(19) United States
(12) Patent Application Publication
(10) Pub. No.: US 2010/0324709 A1
(43) Pub. Date: Dec. 23, 2010

(54) E-BOOK READER WITH VOICE ANNOTATION

(75) Inventor: Leaugonn Starmen, Middletown, CA (US)

Correspondence Address: STAINBROOK & STAINBROOK, LLP, 412 AVIATION BOULEVARD, SUITE H, SANTA ROSA, CA, 95403, US

(73) Assignee: TREE OF LIFE PUBLISHING, San Francisco, CA (US)

(21) Appl. No.: 12/820,073

(22) Filed: Jun. 21, 2010

Related U.S. Application Data
(60) Provisional application No. 61/219,312, filed on Jun. 22, 2009.

(51) Int. Cl. G06F 17/00; G06F 3/16; G06F 3/048

(52) U.S. Cl. 700/94; 715/233; 715/727; 715/810

(57) ABSTRACT

An electronic book reader and e-book reading program for a device having network connectivity capability, the program including a voice annotation feature that enables a user reading an electronic book to highlight selected text and to record a voice annotation related to that highlighted material. The highlighted text and related (linked) voice annotation are saved as a “Voice Note” file, which the user can review, sort, or delete as desired.

### CROSS REFERENCES TO RELATED APPLICATIONS

The present application claims the benefit of U.S. Provisional Patent Application Ser. No. 61/219,312, filed Jun. 22, 2009 (Jun. 22, 2009).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### SEQUENCE LISTING

Not applicable.

### BACKGROUND OF THE INVENTION

1. Field of the Invention

The present invention relates generally to programs for electronic book reading devices, and more specifically to electronic book reading program with a voice annotation function.

2. Background Discussion of Related Art

Reading devices for e-books have achieved extraordinary popularity, owing largely to the dramatic improvements in software and hardware platforms for wireless reading devices. These devices provide a digital format and a physical reading device that generally mimics the experience of reading a print version of a book, including simulated page turning features. The presentation of lengthy documents in a visual display has invited various ways of interacting with and manipulating the text, including highlighting text, saving excerpts, and creating annotations. This latter function has been provided by a number of contemporary “e-book reader” manufacturers and e-book program products. Exemplary devices include, among others, the Amazon KINDLE®, which gives users the means to enter and save annotations using a physical keyboard and to save excerpts from the book of up to a full page in length. The annotations and excerpts (known as “clippings”) are each saved to a data file. The Apple IPAD® provides similar functionality, though in its current version its user interactivity for annotation is actually reduced in relation to the KINDLE. [KINDLE is a registered trademark of Amazon Technologies, Inc., of Reno, Nev.; IPAD is a registered trademark of Apple, Inc., of Cupertino, Calif.]

Many earlier e-book readers are rapidly becoming eclipsed by the above two examples, though they are of historical interest nonetheless. One early version of an e-book reader was offered (and is still offered) by Sony. It goes by the brand name the Sony READER™. This device includes software that enables annotation, highlighting, and search applications. The annotations can be made with a virtual keyboard on a touchscreen or by highlighting and selecting text using a stylus or a finger.

The IREX® Iliad by iRex Technologies is an electronic document reader that receives, processes, transmits, and reproduces electronic messages, publications, newspapers, and periodicals that distributed through electronic means or via the Internet. It enables a user to download and read anything that can be printed by a general purpose computer. The user can make and save notes and can annotate existing documents for later reading or for transfer to a computer or another iLiad. [IREX is a registered trademark of iRex Technologies B.V., Ltd, of Eindhoven, Netherlands.]

The RocketBook E-Book Reader was one of the earliest of the electronic books in the market. It was introduced in 1998 by NuvoMedia Inc., of Palo Alto, Calif., which was later acquired by GemStar TV Guide International. It held the equivalent of approximately 10 novels. The Rocketbook allowed a user to annotate in the margin, underline passages and set bookmarks using a stylus. At present, ROCKETBOOK® has a limited market presence for its e-reader and appears to have shifted its focus to electronic publishing services that include the publication of the text and graphic works of classic literature. [ROCKETBOOK is a registered trademark of Steven Emerson of Portland, Oreg.]

The ETI-2 by E-Book Technologies, Inc., is a reading device that enables user to turn pages and change text orientation with the push of a button. Using the touchscreen, the user can perform a number of “paper functions,” including turning pages, enlarging text, bookmarking pages, highlighting passages, making notes on the touch-sensitive screen and later erasing them, searching for key words, looking up definitions from pre-loaded dictionaries, and hyperlinking to other parts of the book.

There are several other well known e-book readers and e-book reader programs that do not provide annotation functionality.

The foregoing prior art products reflect the current state of the art of which the present inventor is aware. Reference to, and discussion of, these products is intended to provide a general background against which the present invention will be better understood and its novel features better appreciated. This discussion further advances Applicant's acknowledged duty of candor in disclosing information that may be relevant to the examination of prospective claims to the present invention, which will be included in any non-provisional application claiming the benefit of the filing date of the instant application. However, it is respectfully submitted that none of the above-indicated products offer, include, incorporate, disclose, teach, suggest, show, or otherwise render obvious, either singly or when considered in combination, the invention described herein. Specifically, none of the known products provides the user with a way to annotate an electronic book with digital audio file notes (“Voice Notes”) that may be played back at a future time.

### BRIEF SUMMARY OF THE INVENTION

The present invention is an electronic book reading program and program product (E-reader application) especially adapted for an Internet-enabled, multimedia smartphone and/or network connectable table computers. Such phones and tablet computers typically include a multi-touch screen GUI that obviates the need for a physical keyboard, but more importantly, such devices run complete operating system software that provides a platform for application developers, and therefore also provides the ability to run simple applications on generic platforms and advanced applications on specific platforms. Taking advantage of this recently developed functionality, the present invention is an e-reader program for a smartphone or tablet computer that includes a voice annotation feature that enables a user reading an electronic book to highlight selected text and to record a voice annotation related to that highlighted material. The highlighted text and related (linked) voice annotation is then saved as a “Voice Note” file, which the user can later review, sort, or delete.

### BRIEF DESCRIPTION OF THE SEVERAL VIEWS OF THE DRAWINGS

FIGS. 1-4 schematically show in block diagrammatic form the processing steps comprising the method for enabling voice annotation of an e-book of the present invention; and

FIGS. 5-11 are screen shots schematically showing the interaction between a user and the inventive application when text in an e-book is selected by the user in order to create an audio annotation file related to the selected text.

### DETAILED DESCRIPTION OF THE INVENTION

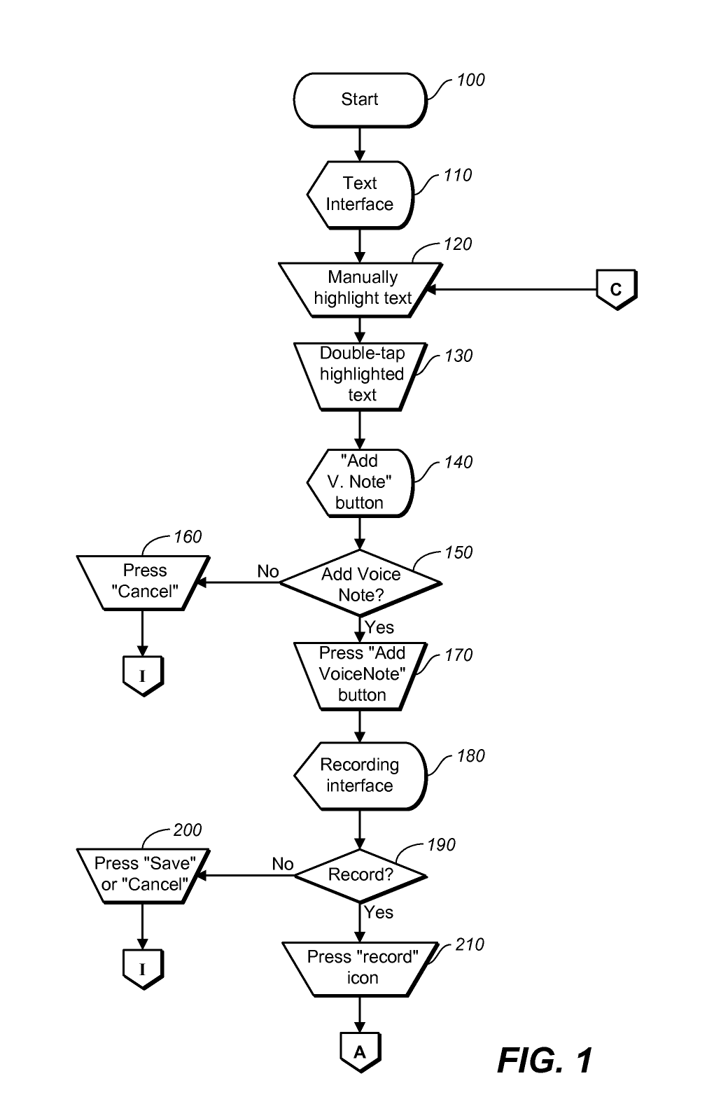

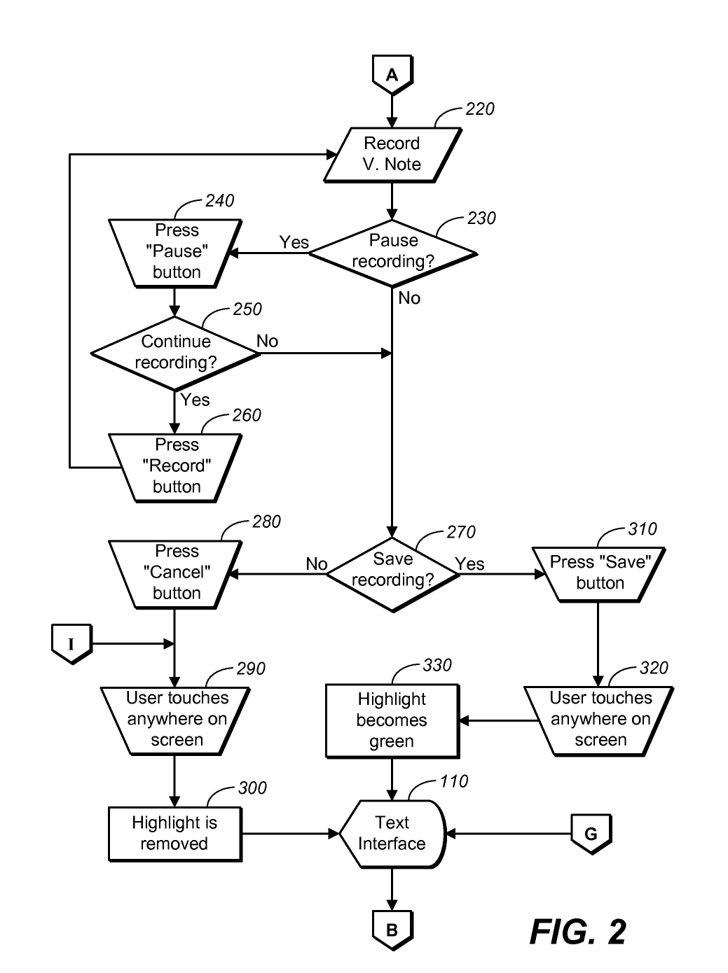

Referring first to FIGS. 1 through 4, wherein like reference numerals refer to like components in the various views, there is illustrated therein in schematic block diagrammatic form a new and improved electronic book reader program including a method of enabling voice annotations for e-books. FIGS. 2-4 each illustrate routines and subroutines to which control is passed from the routines and subroutines set out in the immediately preceding figure, but each may also include routines and subroutines to which control is passed by downstream processing. The flow of such processing is shown by blocks bearing alphabetic references A through I.

Now referring to FIG. 1, the inventive method commences at the program start, denominated 100, which loads a viewable textual interface 110 that runs in the background until a user invokes voice annotation functionality while reading an e-book. In the case of an iPhone or iPod touch (or similar devices) with touchscreen capabilities, the program will provide a user interface on and through the touchscreen so that inputs from the user will be introduced through the touchscreen.

When a user wishes to create an annotation for selected material, he or she manually highlights text 120 by running a finger over the selected material. If he double-taps the highlighted text at block 130, control is passed to block 140 which prompts the user with an “Add Voice Note” button. At decision block 150 the user either elects to add the voice note or declines to do so, and if the latter, he presses “Cancel” at block 160. However, if he elects to add a voice annotation, he presses the “Add Voice Note” button at block 170, and control passes to block 180, which produces a viewable recording interface for user input.

Having elected to add a Voice Note, decision block 190 presents the user with the option to revoke the decision to add a Voice Note, and he may do so by pressing “Save” or “Cancel”, controlled by block 200. If, on the other hand, he wishes to proceed with recording a Voice note, the user presses the “Record” icon, controlled by block 210, and the program activates the device microphone to receive sound input and convey the signals to recordable media in the device so as to record the Voice Note.

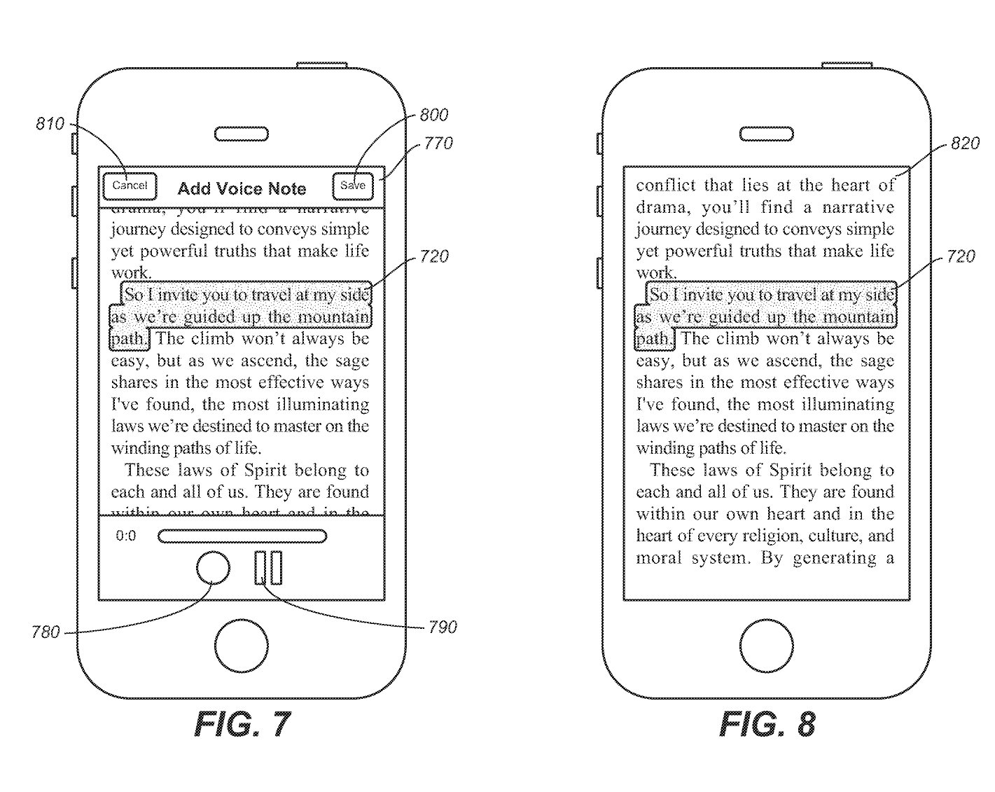

Referring now to FIG. 2, when a user initiates the subroutine to record a voice note, 220, the recording interface will be visually presented to the user, and this interface allows the user to control the record function (see FIG. 7). For instance, if the user wishes to pause the recording, at decision block 230 he or she may do so by pressing a virtual “Pause” button, 240 which is visually displayed during the recording event (see FIG. 7). During the pause, the user is presented with the option of continuing recording at decision block 250 by pressing 260 the record button (see FIG. 7), in which event control is passed back to the Record Voice Note routine at block 220.

If the user does not originally (or does not again) pause the recording, the user will be prompted to save the recording at decision block 270. If the user's decision is not to save the recording, he or she presses the virtual “Cancel” button 280 (again, see FIG. 7), and then touches anywhere on the touchscreen 290, and the highlighting on the material is removed 300.

If the user does wish to save the recorded annotation, he or she presses the virtual “Save” button, and control is passed to block 310, which saves the audible annotation in an annotation data file. After the note is saved, to return to the text interface 110, the user touches anywhere on the screen 320 and the highlighted material changes color 330 (green, for example).

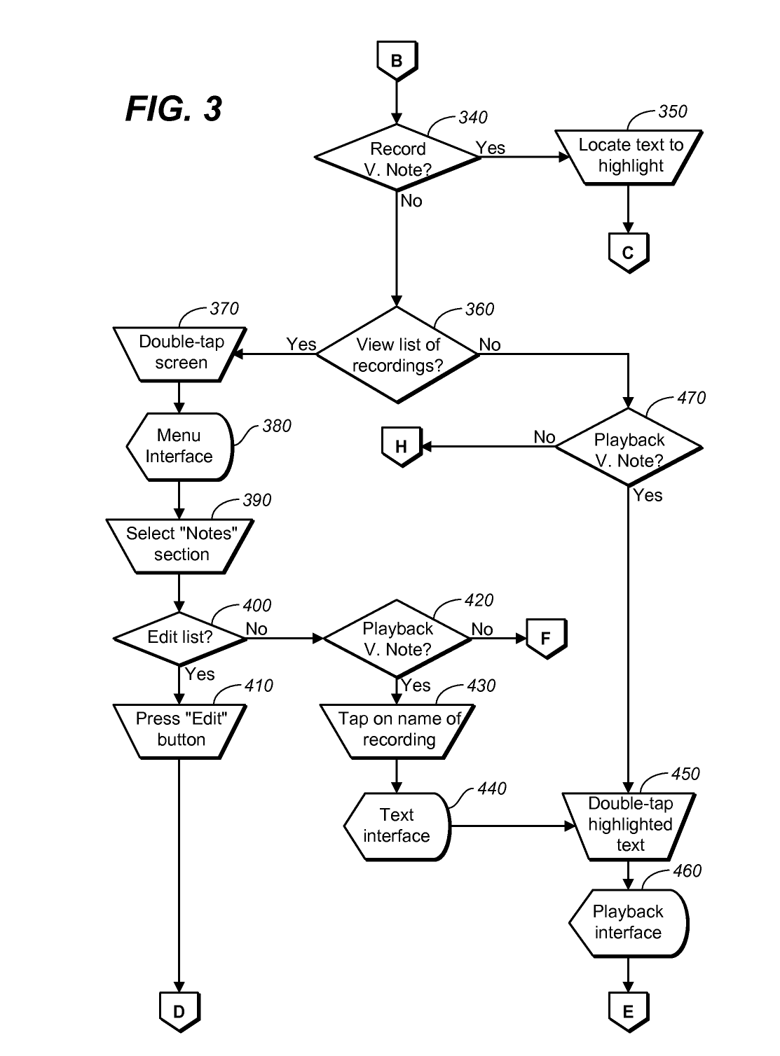

After returning to the text interface, and referring now to FIG. 3, the principal routine set out under reference letter B resumes and at decision block 340 the user may decide to initiate the record function to record a Voice Note. If he or she does so, the user will locate material to highlight 350, and control will pass to the routine set out next to reference letter C in FIG. 1 and at blocks 120 et seq.

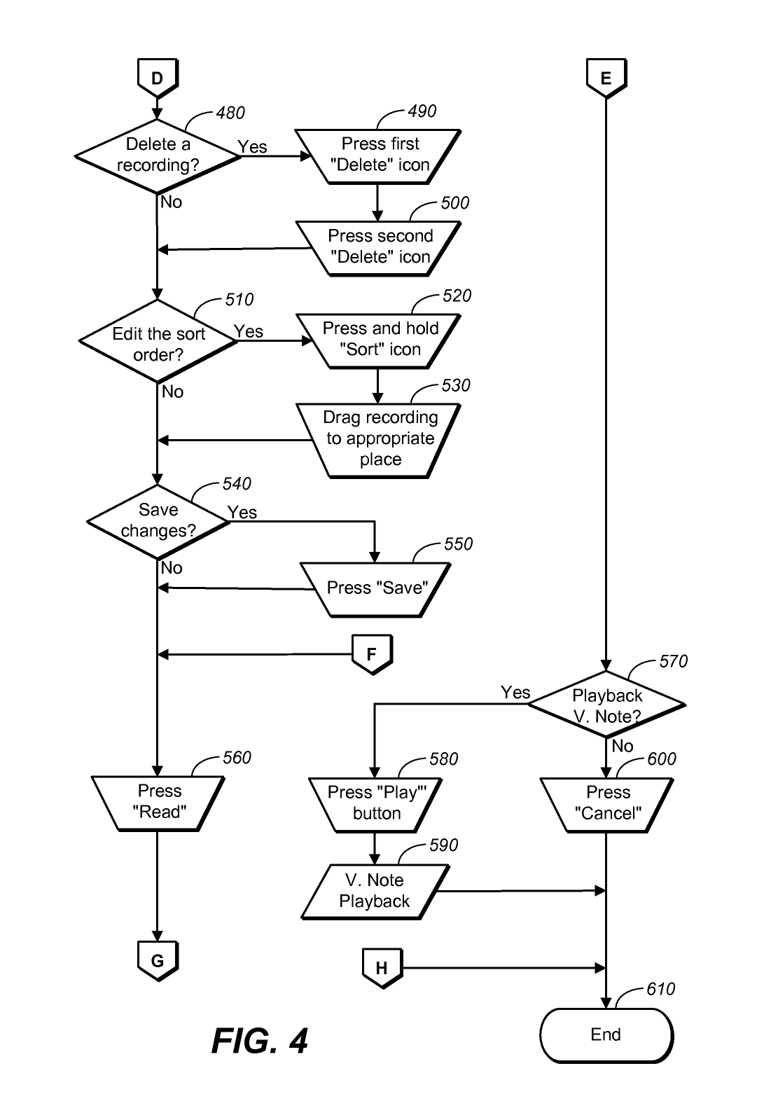

If the user does not wish to record a Voice Note or to record any further Voice Notes, but instead wishes to view a list of recorded annotations, decision block 360, he then double taps the touchscreen 370 and a menu interface 380 is presented. The user may then select 390 the virtual “Notes” button on the interface and the annotations will be listed in an order according to the date at which the annotation was made or the particular place in the textual material to which the note pertains. At decision block 400, the user may elect to edit the list of notes, in which event he or she presses the virtual “Edit” button 410. Control then passes to the routine set out under reference letter D in FIG. 4 and via blocks 480 et seq.

If after pressing the virtual “Notes” button the user decides not to edit the list of annotations at decision block 400, the user will be presented with the option of playing back a Voice Note at decision block 420. If the user wishes to playback a Voice Note, he or she taps on a selected recording 430 and a textual interface is presented 440 showing the highlighted text to which the recorded annotation pertains. The user double taps the highlighted text and the playback interface is then presented 450. Control passes to the routine set out at reference letter E in FIG. 4, and via blocks 570 et seq.

If the user declines to play back a Voice Note, control will pass to the routine set out next to reference letter F in FIG. 4.

If after electing to view the list of recordings at decision block 360 the user decides not to playback a Voice Note 470, control passes to the subroutine that terminates the playback routine set out next to reference letter H in FIG. 4.

If the user has elected to edit the annotation list at decision block 400 and has pressed the edit button at block 410, the user will be presented with the decision 480 to delete the recording. If he or she decides to delete the recording, he or she presses a first delete icon 490, and then confirms the deletion by pressing a second delete icon 500. Control then passes back to the primary editing subroutine. If he or she does not wish to delete the recorded annotation but wishes instead to edit the sort order at decision block 510, the “Sort” icon is pressed, and the user is enabled to drag 530 a selected annotation to another location in the list. Control then passes back to the primary editing subroutine.

After deleting a recording or changing the sort order, or if the user neither wishes to delete or reorder annotations, the user will be prompted with the query about saving any changes made at decision block 540. To effect a save function, the user simply presses a virtual “Save” button 550. If the user does not wish to save changes, he or she presses a virtual “Read” button 560 and control passes to the routine set out after reference letter G in FIG. 2.

If the user is presented with the playback interface 460 during execution of the Voice Note playback subroutine, and if the user has maintained the decision 570 to playback the Voice Note, he or she simply presses the virtual “Play” button 580 and the annotation is played back 590 through the device audible output speaker. If the user has changed his mind, he simply presses a virtual “Cancel” button 600 and the playback subroutine ends 610.

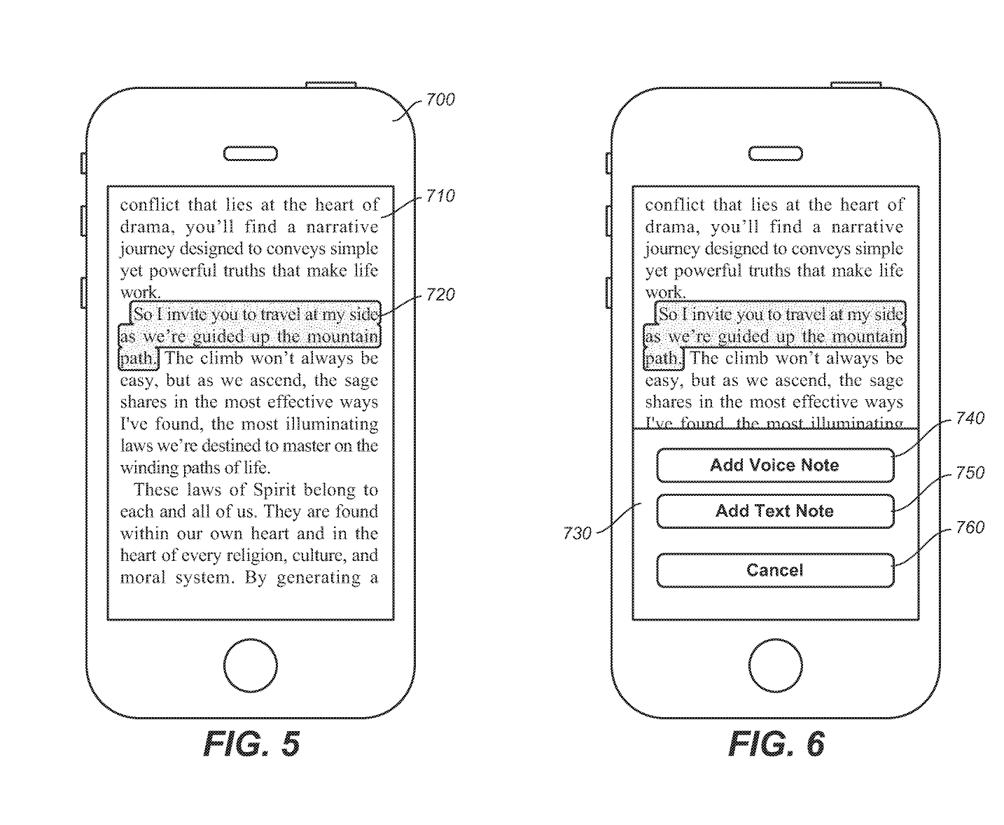

Exemplary screen shots illustrating and corresponding to the implementation of the above-described method are shown in FIGS. 5-11. FIG. 5 shows that when reading an electronic book on a multimedia playback device 700 having a touchscreen 710, a user may highlight selected textual material 720 by touching the touchscreen over displayed material (text and/or graphics) for two seconds or longer and then dragging a finger across material in the immediate proximity of the finger. Referring to FIG. 6, if the user then taps twice on the highlighted material, a prompt 730 is visually displayed that provides the user with the option to “Add Voice Note” 740 or “Add Text Note” 750 or “Cancel” 760 the annotation function. FIG. 7 shows that if the user taps on “Add Voice Note,” an audio recording interface 770 will appear at the bottom as well as at the top of the touchscreen. The highlighted text will remain visible at the center of the touchscreen. The color of the highlight can be customized by the user by setting application preferences in an application preferences pane.

If the user next taps the virtual record button 780 on the touchscreen, the application will enable voice input at the phone microphone and will initiate a recording event for a voice annotation spoken by the user. If the user taps on the pause button 790, the recording will pause. If the user taps on the record button again, the recording resumes where it left off. If the user taps the virtual “Save” button 800, the highlight color of the text will become bright green once the user taps anywhere on the screen. If the user taps on the virtual “Cancel” button 810, the textual interface 820 returns (see FIG. 8).

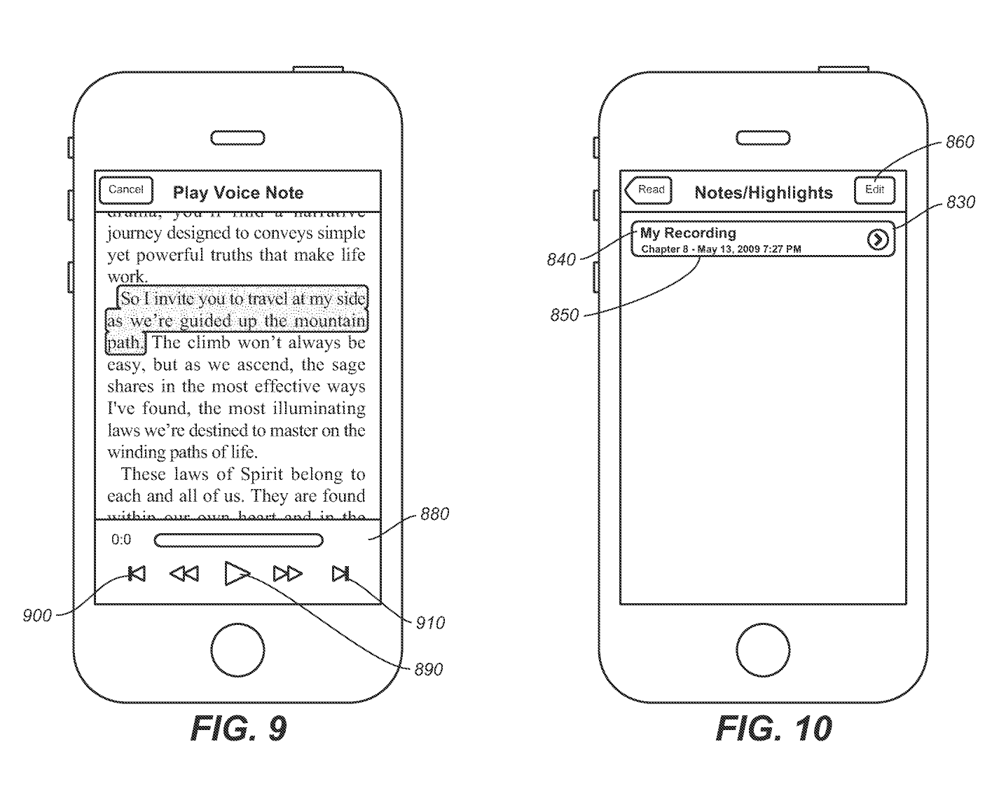

Once a recorded voice annotation has been saved, this audio file (recording) is permanently associated with the highlighted text, unless the user deletes that recording. The saved recorded annotation can thereafter be accessed in two different ways: (1) by double-tapping on the green highlighted text (enabling the user to playback, rewind and fast-forward that recording) (see FIG. 9); or (2) by accessing the Notes section within the menu of the e-book reading program where all Voice Notes are displayed (see FIG. 10) as a list of highlighted text selections and associated playback buttons.

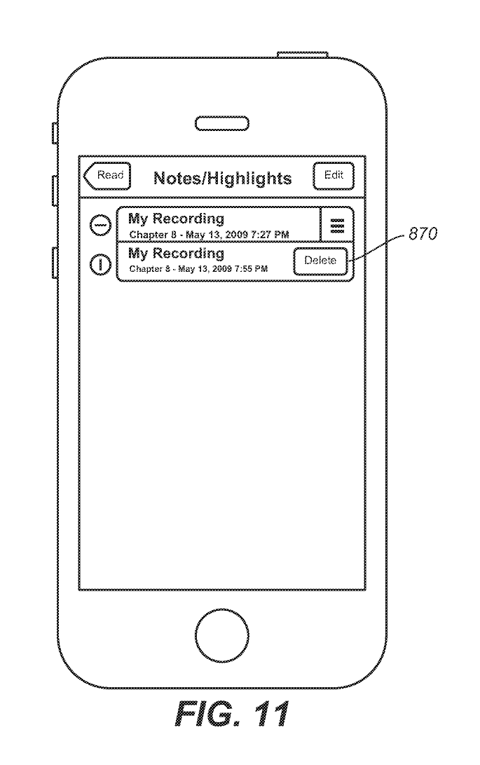

Each recording 830 is registered and listed in the Notes section within the menu of the e-book reader as a “My Recording” file 840 and bears a subtitle 850 showing the general location of the recording (e.g., “Chapter 1”), followed by the specific date and time of the recording (e.g., “May 13, 2009 1:17 PM”). By tapping the virtual “Edit” button 860 within the Notes section, the user now has the option to either delete the recording using a virtual “Delete” button 870, or change the recordings display position on the screen (applicable when there are multiple Voice Notes saved) (see FIG. 11). Once a recording is deleted, the text that was formerly associated with that recording is no longer highlighted.

This list enables the user to select any recording associated with highlighted text. By tapping on a Voice Note within the list the user is taken out of the menu interface and is brought back into the text interface to the exact location of the highlighted text associated with the Voice Note. When the user then double-taps the green highlighted text, the playback interface 880 is activated and the user has the option to playback 890, rewind 900, and fast forward 910 that recording.

The above disclosure is sufficient to enable one of ordinary skill in the art to practice the invention, and provides the best mode of practicing the invention presently contemplated by the inventor. While there is provided herein a full and complete disclosure of the preferred embodiments of the e-reader of the present invention, it is not desired to limit the invention to the exact construction and operation shown and described. Various modifications, alternative constructions, changes and equivalents will readily occur to those skilled in the art and may be employed, as suitable, without departing from the true spirit and scope of the invention. Accordingly, the above description and illustrations should not be construed as limiting the scope of the invention, which is defined by the appended claims.

What is claimed as invention is:

1. An e-book reader, comprising:
a network connectable multimedia playback device;
an operating system loaded on said multimedia playback device; and
an e-book reader application running on said operating system, said e-book reader application having a voice annotation function that enables a user to highlight selected text and to record a voice annotation related to the highlighted material.

2. The e-book reader of claim 1, wherein said voice annotation function includes a routine that enables a user to save said voice annotation as a voice note file.

3. The e-book reader of claim 2, wherein said voice annotation function enables a user to review, sort, or delete said voice annotation.

4. A method of enabling voice annotations for e-books, said method comprising the steps of:
(a) providing a network connectable multimedia playback device having a microphone for recording sounds, and a touch screen for user inputs and for visually displaying textual and graphical information, the multimedia playback device including an operating system that enables a user to run an e-book reader program;
(b) providing an e-book reader program with voice annotation functionality, the e-book reader program presenting on the screen a viewable textual interface and a voice annotation function that runs in the background while a user reads an e-book and until the user manually invokes the voice annotation function;
(c) selecting material for annotation by highlighting text using by manually running at least one finger over the material to be highlighted;
(d) visually presenting to the user with a visual input option to choose to add a voice note;
(e) choosing to add a voice note;
(f) activating the multimedia playback device microphone; and
(g) recording a voice note.

5. The method of claim 4, further including the steps of:
(h) presenting the user with an option to save or the voice note recorded at step (g); and
(I) choosing to save the voice note.

6. The method of claim 4, further including the step of:
(j) providing the user with an option to revoke the decision to add a voice note by making a user input; and
(k) making an input in response to step (j).

7. The method of claim 4, wherein when the subroutine at step (d) is initiated to present a user with a visual input option to add a voice note, the method includes the further step of presenting a recording interface that allows the user to control the record function, including visually presenting a virtual “pause” button during the recording event.

8. The method of claim 7, further including the step of presenting a user with a virtual “record” button during a pause in recording.

9. The method of claim 7, further including the step of presenting a user with a virtual “cancel” button during a pause in recording.

10. The method of claim 7, further including the step of presenting a user with a virtual “save” button for use by the user if he or she wishes to save a recorded annotation.

11. The method of claim 7, further including step of presenting a menu interface for a user to obtain a visual listing of saved recorded annotations.

12. The method of claim 11, further including the step of providing the user with the option of editing saved recorded annotations.

13. The method of claim 4, further including the step of providing the user with a visual interface providing options to playback, edit, sort, and delete recorded voice annotations.

14. An e-book reader program for use with a network connectable multimedia playback device having a microphone for recording sounds, a touch screen for user inputs and for visually displaying textual and graphical information, and an operating system that enables a user to run an e-book reader program, said e-book reader program including a voice annotation function for recording a voice file in relation to text manually selected and highlighted by a user.

15. The e-book reader of claim 14, wherein said e-book reader program presents on the touch screen a viewable textual interface, and wherein said voice annotation function runs in the background while a user reads an e-book and until the user manually invokes said voice annotation function.
